(19) United States
(12) Patent Application Publication
(10) Pub. No.: US 2017/0178158 A1
(43) Pub. Date: Jun. 22, 2017

(54) SYSTEMS AND METHODS FOR MANAGING ELECTRICITY CONSUMPTION ON A POWER GRID

(71) Applicant: MOAI Solutions Inc., Toronto (CA)

(72) Inventors: Stephen Yuangi Chen, Toronto (CA); Mario Leonardo Morfin Ramírez, Toronto (CA); Terri Oi-Li Chu, Toronto (CA); Robert Michael Burko, Toronto (CA); Riad Hartani, Vancouver (CA)

(21) Appl. No.: 15/156,716

(22) Filed: May 17, 2016

Related U.S. Application Data
(60) Provisional application No. 62/270,707, filed on Dec. 22, 2015.

(51) Int. Cl. G06Q 30/02; G05F 1/66; G06Q 50/06

(52) U.S. Cl. CPC G06Q 30/0202; G06Q 50/06; G05F 1/66

(57) ABSTRACT

Systems and methods of managing electricity consumption on a power grid are disclosed herein. The method may include: receiving preference data indicating preferences for usage of a network-connected electricity-consuming device during a time range; receiving a forecasted availability of electricity on the power grid during the time range; determining an optimal electricity consumption level for the power grid that matches the forecasted availability of electricity during the time range, where the optimal electricity consumption level includes electricity to be consumed by the device during the time range indicated in the preference data; and determining a private price for electricity consumed by the device during the time range, the private price being different from a public price of electricity during the time range. The private price can be determined so that the optimal electricity consumption level, when adjusted for the altered consumption of the device as a result of the private price, matches the forecasted energy availability during the time range is achieved.

### CROSS-REFERENCE TO RELATED APPLICATIONS

This application claims the benefit of U.S. Provisional Patent Application No. 62/270,707, filed on Dec. 22, 2015, the entire contents of which are hereby incorporated by reference.

### FIELD OF THE DISCLOSURE

The present disclosure relates generally to systems and methods for managing electricity consumption on a power grid.

### BACKGROUND

Physical items, such as those which collectively form the “Internet of Things” (IoT), are increasingly being developed with sensors, controllers, and computing processing/networking capabilities that allow the physical items to collect information about their environments, communicate the collected data, and perform actions remotely. In some cases, such physical items may be provided with software functionality that identifies patterns within the collected data, so that the physical item can be controlled in a manner that provides optimal results locally at the environment within which a given physical item is placed.

For example, a “smart thermostat” that is part of a home automation system can learn the energy needs of a single house and identify patterns of usage at the household. Based on the learned pattern of usage, the smart thermostat may optimize the energy consumption locally within that house. In hot climates, this might involve the smart thermostat reducing the usage of energy-intensive cooling mechanisms such as air conditioning when the house is vacated during the day, and restoring usage to normal levels in the late afternoon/evening when the occupants typically return to the house.

While the smart thermostat behaving in this manner may achieve an optimal (e.g., in this case, minimal) level of energy consumption locally within that particular house, such behaviour may not lead to a globally optimal solution of energy consumption for the power grid that the smart thermostat is connected to. This is because a large number of smart thermostats connected to the power grid behaving in a similar manner may actually add to the peak demand already experienced by the power grid during the late afternoon/evening period.

In another example, a “smart meter” may be installed at a house to collect data regarding the time of day when usage of utility resources (e.g., electricity) occurs. While these smart meters allow for more accurate time-of-day metering (which may, in turn, allow for time-of-day or time-of-use (TOU) based pricing to match demand periods during the day), such systems do not allow for coordination of consumption behaviour amongst multiple households (e.g., to reduce or increase consumption for global optimums related to the power grid).

There is thus a need for improved methods and systems of coordinating activity amongst network-connected electricity-consuming devices.

### BRIEF DESCRIPTION OF THE DRAWINGS

Non-limiting examples of various embodiments of the present disclosure will next be described in relation to the drawings, in which:

FIG. 1 is a high-level view of data and action flows during traditional methods of managing electricity consumption;

FIG. 2 is a high-level view of data and action flows that allow for increased coordination amongst network-connected electricity consuming devices, in accordance with at least one embodiment of the present disclosure;

FIG. 3 is a block diagram of a system for collecting preference data from network-connected electricity-consuming devices and outputting global optimums, in accordance with at least one embodiment of the present invention;

FIG. 4 is a flowchart diagram for a method of managing electricity consumption on a power grid, in accordance with at least one embodiment of the present invention;

FIG. 5 is a diagram illustrating traditional techniques used to locate global optimums; and

FIG. 6 is a diagram illustrating techniques used to locate global optimums when the Leaders and Followers (LaF) technique is used.

### DETAILED DESCRIPTION

In a broad aspect of the present disclosure, there is provided a method of managing electricity consumption on a power grid. The method may include: receiving, for a first network-connected electricity-consuming device connected to the power grid, first preference data indicating preferences for usage of the first device during a time range; receiving a forecasted availability of electricity on the power grid during the time range; determining an optimal electricity consumption level for the power grid that matches the forecasted availability of electricity during the time range, wherein the optimal electricity consumption level includes electricity to be consumed by the first device during the time range indicated in the first preference data; and determining a first private price for electricity consumed by the first device during the time range, the first private price being different from a public price of electricity during the time range; wherein the first private price is determined so that the optimal electricity consumption level, when adjusted for the altered consumption of the first device as a result of the first private price, matches the forecasted energy availability during the time range is achieved.

In some embodiments, the method may also include: receiving, for a second network-connected electricity-consuming device connected to the power grid, second preference data indicating preferences for usage of the second device during a time range, wherein the second preference data is received prior to the determining of the optimal electricity consumption level, and the optimal electricity consumption level includes electricity to be consumed by the second device during the time range as indicated in the second preference data; and determining a second private price for energy consumed by the second device during the time range, the second private price being different from the public price of electricity during the time range, and wherein the second private price is available to the second device simultaneous with the first private price being made available to the first device; wherein the second private price is determined so that the optimal electricity consumption level, when adjusted for the altered consumption of the second device as a result of the second private price, matches the forecasted energy availability during the time range is achieved.

In some embodiments the second private price may be different from the first private price.

In some embodiments, the optimal electricity consumption level is a substantially flat demand between the first device and the second device during the time range, and the first private price and the second private price are determined in a coordinated matter to achieve the flat demand.

In some embodiments, the forecasted availability of electricity is greater than a forecasted electricity consumption level for the power grid, and the first private price is determined to be lower than the public price, so that the electricity consumed by the first device will increase to achieve the optimal electricity consumption level that matches the forecasted availability of electricity.

In some embodiments, the first preference data includes an indication that the first device may be operated at any time during the time range, and the first private price is determined in part based on a size of the time range associated with the first preference data.

In some embodiments, the first device is capable of being operated in a plurality of operational settings that each consume different amounts of electricity when the first device is used with the operational setting, and wherein the first preference data includes an indication of a subset of the plurality of the operational settings that the first device can be used with during the time range, and wherein the first private price is determined in part based on the subset of the plurality of operational settings.

In some embodiments, the Leaders and Followers (LaF) optimization technique is used to determine the optimal electricity consumption level.

In some embodiments, the method includes determining the optimal electricity consumption level for the power grid during the time range, the method further includes pre-calculating feasible solutions using a stochastic solution generator and the feasible solutions includes the first private price for electricity consumed by the first device during the time range.

In some embodiments, the feasible solutions are validated against live conditions of the power grid, and upon successful validation, the first private price is transmitted to the first device.

In a broad aspect of the present disclosure, there is provided a computer readable medium storing instructions to manage electricity consumption on a power grid, the instructions for execution by one or more processors, wherein when the instructions are executed by the one or more processors, the one or more processors: receive, for a first network-connected electricity-consuming device connected to the power grid, first preference data indicating preferences for usage of the first device during a time range; receive a forecasted availability of electricity on the power grid during the time range; determine an optimal electricity consumption level for the power grid that matches the forecasted availability of electricity during the time range, wherein the optimal electricity consumption level includes electricity to be consumed by the first device during the time range indicated in the first preference data; and determine a first private price for electricity consumed by the first device during the time range, the first private price being different from a public price of electricity during the time range; wherein the first private price is determined so that the optimal electricity consumption level, when adjusted for the altered consumption of the first device as a result of the first private price, matches the forecasted energy availability during the time range is achieved.

In a broad aspect of the present disclosure, there is provided a network-connected electricity-consuming device, the device including: a processor configured to control usage of the device according to preference data indicating preferences for usage of the device during a time range; wherein the processor is further configured to receive a private price for electricity consumed by the device, the private price being different from a public price of electricity during the time range, and wherein the private price is determined so that a forecasted optimal electricity consumption level for the power grid during the time range, when adjusted for the altered consumption of the first device as a result of the first private price, matches a forecasted energy availability on the power grid during the time range.

In a broad aspect of the present disclosure, there is provided a system for managing electricity consumption on a power grid, the system including: a first network-connected electricity-consuming device connected to the power grid; and a server communicably connected to the first network-connected electricity-consuming device, wherein the server includes one or more processors and one or more memories storing instructions which, when executed by one or more processors, cause the one or more processors to: receive, for the first network-connected electricity-consuming device connected to the power grid, first preference data indicating preferences for usage of the first device during a time range; receive a forecasted availability of electricity on the power grid during the time range; determine an optimal electricity consumption level for the power grid that matches the forecasted availability of electricity during the time range, wherein the optimal electricity consumption level includes electricity to be consumed by the first device during the time range indicated in the first preference data; and determine a first private price for electricity consumed by the first device during the time range, the first private price being different from a public price of electricity during the time range; wherein the first private price is determined so that the optimal electricity consumption level, when adjusted for the altered consumption of the first device as a result of the first private price, matches the forecasted energy availability during the time range is achieved.

In some embodiments, the system includes a second network-connected electricity-consuming device connected to the power grid; wherein the server is communicably connected to the second network-connected electricity-consuming device, and the server is further configured to: receive, for the second network-connected electricity-consuming device connected to the power grid, second preference data indicating preferences for usage of the second device during a time range, wherein the second preference data is received prior to the determining of the optimal electricity consumption level, and the optimal electricity consumption level includes electricity to be consumed by the second device during the time range indicated in the second preference data; and determine a second private price for energy consumed by the second device during the time range, the second private price being different from the public price of electricity during the time range, and wherein the second private price is available to the second device simultaneous with the first private price being made available to the first device; wherein the second private price is determined so that the optimal electricity consumption level, when adjusted for the altered consumption of the second device as a result of the second private price, matches the forecasted energy availability during the time range is achieved.

In some embodiments the second private price may be different from the first private price.

In some embodiments, the optimal electricity consumption level is a substantially flat demand between the first device and the second device during the time range, and the first private price and the second private price are determined in a coordinated matter to achieve the flat demand.

In some embodiments, the forecasted availability of electricity is greater than a forecasted electricity consumption level for the power grid, and the first private price is determined to be lower than the public price, so that the electricity consumed by the first device will increase to achieve the optimal electricity consumption level that matches the forecasted availability of electricity.

In some embodiments, the first preference data includes an indication that the first device may be operated at any time during the time range, and the first private price is determined in part based on a size of the time range associated with the first preference data.

In some embodiments, the first device is capable of being operated in a plurality of operational settings that each consume different amounts of electricity when the first device is used with the operational setting, and wherein the first preference data includes an indication of a subset of the plurality of the operational settings that the first device can be used with during the time range, and wherein the first private price is determined in part based on the subset of the plurality of operational settings.

In some embodiments, the server uses the Leaders and Followers (LaF) optimization technique to determine the optimal electricity consumption level.

In some embodiments, when determining the optimal electricity consumption level for the power grid during the time range, the server is further configured to pre-calculate feasible solutions using a stochastic solution generator, and the feasible solutions includes the first private price for electricity consumed by the first device during the time range.

In some embodiments, the feasible solutions are validated against live conditions of the power grid, and upon successful validation, the first private price is transmitted to the first device.

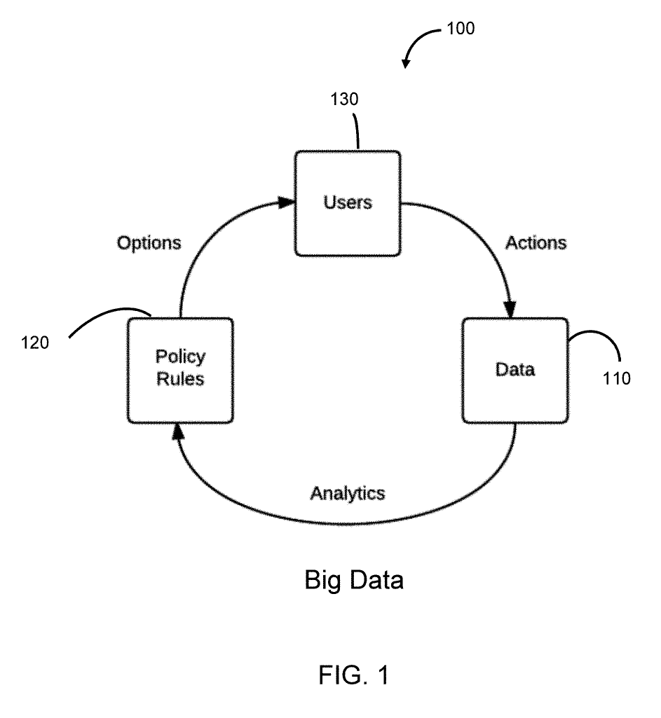

Referring to FIG. 1, shown there generally as 100 is a high-level view of data and action flows during traditional methods of managing electricity consumption. In some instances, these types of data and action flows may be associated with so-called analysis performed in “Big Data” environments. As illustrated, the data 110 may first be collected from a variety of network-connected electricity-consuming devices (or “networked devices” below). This data is provided into a data analysis tool to perform a decision making process based on policy rules 120 using the data 110. This decision making process may involve generating predictive models so as to provide options back to the users 130.

For example, the networked devices may be smart meters that collect energy usage data for a set of residential customers. Specifically, the actions of the users 130 (e g running a dishwasher) produce data 110 on energy consumption that is collected and transmitted by the smart meters. Utilities operating the power grid may then receive and perform analytics on this collected data 110. These analytics may lead to a demand model in the policy rules 120 which can be used for internal or external decision making processes. An example of an internal decision is for a utility to use the predicted demand from the demand model to optimize the purchase of future supply contracts to reduce its costs to meet this demand.

In an external decision, the predicted demand can be used to create new options to be presented to the users 130. For example, flat prices for electricity often led to large demand peaks in the early evening hours (when residential users would return home from work and begin to cook dinner). If the peak demand is sufficiently large, it can exceed the capacity of the power grid. Thus, an attempt at optimizing energy consumption may be desired. Such traditional attempts may involve the establishment of TOU pricing for energy consumption. For example, TOU pricing may involve setting a high price during the evening period of peak demand to reduce demand for electricity, and setting low price in the late evening or early morning period to encourage electricity use in periods of low demand.

The introduction of TOU pricing (e.g. new options for the users 130 as developed by the decision making process according to policy rules 120) may lead to shifted electricity consumption (e.g., users 130 running their dishwasher later in the evening). These new actions of the users 130 may then create new data 110 which can again be processed through the data analytics to create a new demand model for decision making. If new options for the users 130 are created by the policy rules 120 based on this new data 110, the “Big Data” cycle may begin again.

Notably, a characteristic of TOU price systems or peak price systems based on forecasted demand (e.g., anticipated high demand based on a forecasted hot day) is that they use public prices—e.g., prices that are the same for all electricity consumers connected to the grid. As discussed below, some of the embodiments discussed herein may provide for private prices that allow for greater granularity of control over the electricity demand by networked devices.

The cycle of FIG. 1 is unidirectional and the decision-making is being performed in a reactive manner to historical data. Specifically, the data analytics in the environment of FIG. 1 are being performed on data from events that have already occurred in the past. While analysis of such historical data may allow the finding of statistical correlations within the data, the analysis may not allow for the result of the analysis to simultaneously and dynamically impact the live environment. In the example situation of smart meters, the prices are set in a unilateral way by operators of the power grid based on historical data without taking into account the actual demand at any given time. Prices are communicated to electricity consumers, and their demand usage is reported after the fact.

Also, in the traditional system of FIG. 1, there is no coordination amongst the multiple devices from which data are respectively collected. Individual devices and households may be operating without knowledge of each other, and causing a spike in demand regardless of whether it is actually important to a particular user 130 that consumption occurs during the peak period. As a result, prices are unilaterally set by the power utility based on aggregate demand because the setting of public prices is one of a minimal number of ways to manage and shift demand. As discussed below, the present embodiments allow for the networked devices to coordinate their consumption in view of the amount of electricity available on the power grid.

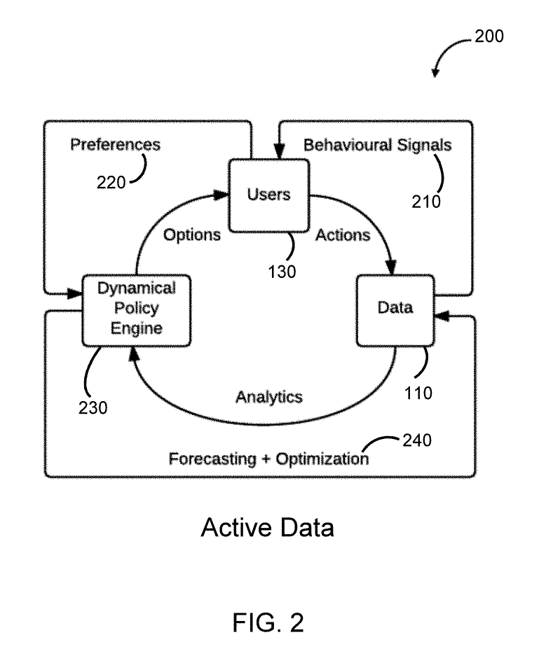

Referring to FIG. 2, shown there generally is a high-level view of data and action flows that allow for increased coordination amongst network-connected electricity consuming devices, in accordance with at least one embodiment of the present disclosure. One or more features of the illustrated bi-directional data and action flows of networked physical items are called “Active Data” herein. As illustrated, the unidirectional data and action flows of FIG. 1 are shown as the inner circle of action and data flows (shown with clockwise directional arrows). However, in FIG. 2, there is also counter-directional data and action flow amongst the same entities (shown with counter-clockwise directional arrows).

Instead of collected data simply being provided into a data analysis tool, the embodiment of FIG. 2 may also additionally or alternatively provide data amongst the networked devices themselves to produce a coordinated effort at achieving a desired outcome. This is shown in FIG. 2 as behavioural signals 210. For example, in examples where the networked devices are smart meters or smart thermostats, such devices may communicate with other similar devices connected to the same power grid to coordinate energy consumption activities in a manner that provides mutual benefit amongst the connected devices for users 130. In some environments, this may be considered as a form of swarm intelligence of the networked devices.

In the example scenario of smart thermostats attempting to learn the schedules of times of day when occupants are within a house, such coordinated activity may allow a smart thermostat to determine the times of days when the occupants of neighboring houses are present within their homes. To the extent that the occupants of the neighboring house are absent from their home when the occupants of the given smart thermostat's house are present (e.g., if the neighbor happens to work a night shift when the occupants of the given smart thermostat's house are present), the respective smart thermostats of the two homes may be able to coordinate their energy consumption so as provide a consistent (e.g., flat) level of energy consumption across the two houses.

In another example, if a set of houses each want their dishwasher operated in the time range of 6:00 pm and 6:00 am, the two households may coordinate their usage so that the collective energy consumption is flat (e.g., staggering operation of the dishwashers in different households). As compared to traditional methods which attempt to manage electricity consumption via TOU pricing, the present embodiments may serve to avoid peaks at particular times (for example, exactly at 6:00 pm or exactly at 12:00 am when a new price comes into effect at a particular time window). In some embodiments, the users 130 may not need to program their dishwasher with the exact time when the dishes are going to be washed, but rather merely provide the window of time that the operation would be preferred.

In some embodiments, this type of coordinated activity may be used to collectively negotiate energy pricing by consumers. For example, the ability for the networked devices to provide behavioural signals 210 amongst themselves may turn a seller's market in which the power utility unilaterally sets the price into a hybrid market, in which purchasers can collectively capitalize on the predictability of their consumption patterns. This coordinated activity may be considered to be creating a virtual team of users 130 that can collectively negotiate the energy price; e.g., by not consuming energy when it is expensive, and by making the collective behaviour of the networked devices more predictable. In this manner, these virtual teams may have enough influence over the energy prices to collectively negotiate such public price. This may result in pricing that is different from typical TOU-type pricing (e.g., even though peak periods for the power grid may typically be associated with higher costs, the coordinated activity may actually show that the group energy consumption is low and should therefore result in lower prices/costs).

Additionally or alternatively, instead of having the networked devices collect data 110 solely for input into a data analysis tool (which then performs processing to generate predictive models about the data 110, as discussed in relation to FIG. 1), the embodiment of FIG. 2 configures the networked devices to send/emit data about the preferences that the items desire in the environment in which it is located. This “preferences” data 220 may relate to future demands that the networked items desire to achieve in that particular environment. As used herein, the term “preference data” refers to information about the future usage of a given networked device that would impact the electricity demands of the device. For example, the preference data 220 may be an indication that the device can be operated at any time during a given time range (e.g., “a dishwasher may be run at any time, so long as its run is complete by 6 am the next morning” or “the heater may come on at any time, so long as the house achieves a temperature of 21 degrees Celsius by 6 pm”). Additionally or alternatively, the preference data may specify operational settings of the networked device that each consumes different amounts of electricity when the device is used with the operational setting. For example, if a networked device is a dishwasher, there may be settings for “hi-temperature wash” or “heated dry”, which if selected, would result in more electricity consumption than if these settings were not selected. As discussed in greater detail below, the private price for electricity to be offered to a given networked device may be determined, in part, on the size of the time range and/or the subset of the operational settings in the preference data 220.

In FIG. 2, this preference data 220 is provided to a more sophisticated dynamical policy engine 230 (described below) that performs multi-scale optimization and dynamically models the data based on both the historical usage data 110 and the preference data 220. This results in forecasting and optimization 240 that is fed back into the data 110 inputted into the dynamical policy engine 230. At the same time, the output of the dynamical policy engine 230 may generate options (e.g., private prices for energy consumption) that for users 130. Since the dynamical policy engine 230 performs optimizations not just on historical data 110 but also on preference data 220 which indicate future desired energy consumption of networked devices, activity amongst the multiple networked devices may be coordinated to achieve a collective or global optimum that may be beneficial to all networked physical items in a given environment.

The dynamical policy engine 230 employs dynamical modelling. Notably, this is different from a dynamic model. A dynamic model is a model that changes. However, these changes are within the parametric operating ranges of that particular model. For example, it is necessary for utilities to set a public price for electricity that will balance supply and demand. As supply increases (e.g. due to increasing output from alternative energy sources such as wind or solar), a utility may lower the price to try to increase demand A model which can handle real-time changes to wind power production might be considered a dynamic model.

However, if there is so much wind and/or solar generation that the system is completely overwhelmed, a dynamic model may only be able to react by creating a negative price that encourages one power utility to pay another power utility take electricity out of their grid. This illustrates the limitation of a dynamic model because there is no public price available that can balance supply and demand (without resorting to demand in another jurisdiction that is outside of the traditional consumers of a given power utility).

In the dynamical modelling employed herein, there exists the capability to adjust the model itself. This can be visualized as having multiple distinct models operating in parallel where each of these models has the scope of a dynamic model. This ability to handle multiple models may allow for the determination of private prices for multiple, overlapping situations that may occur when trying to solve multiple problems such as load balancing and load matching at the same time.

In FIG. 2, the behavioural signals 210 allowing for coordinated activities amongst multiple networked devices to be achieved, the transmission of preferences data 220 from networked devices, and the use of the dynamical policy engine 230 to generate forecasts and perform optimization 240 based on dynamical modelling are shown as working together in a collective system. However, in some embodiments, one or more of these features may be employed without any of the other(s), and in some other embodiments, one or more of the components might be implemented together.

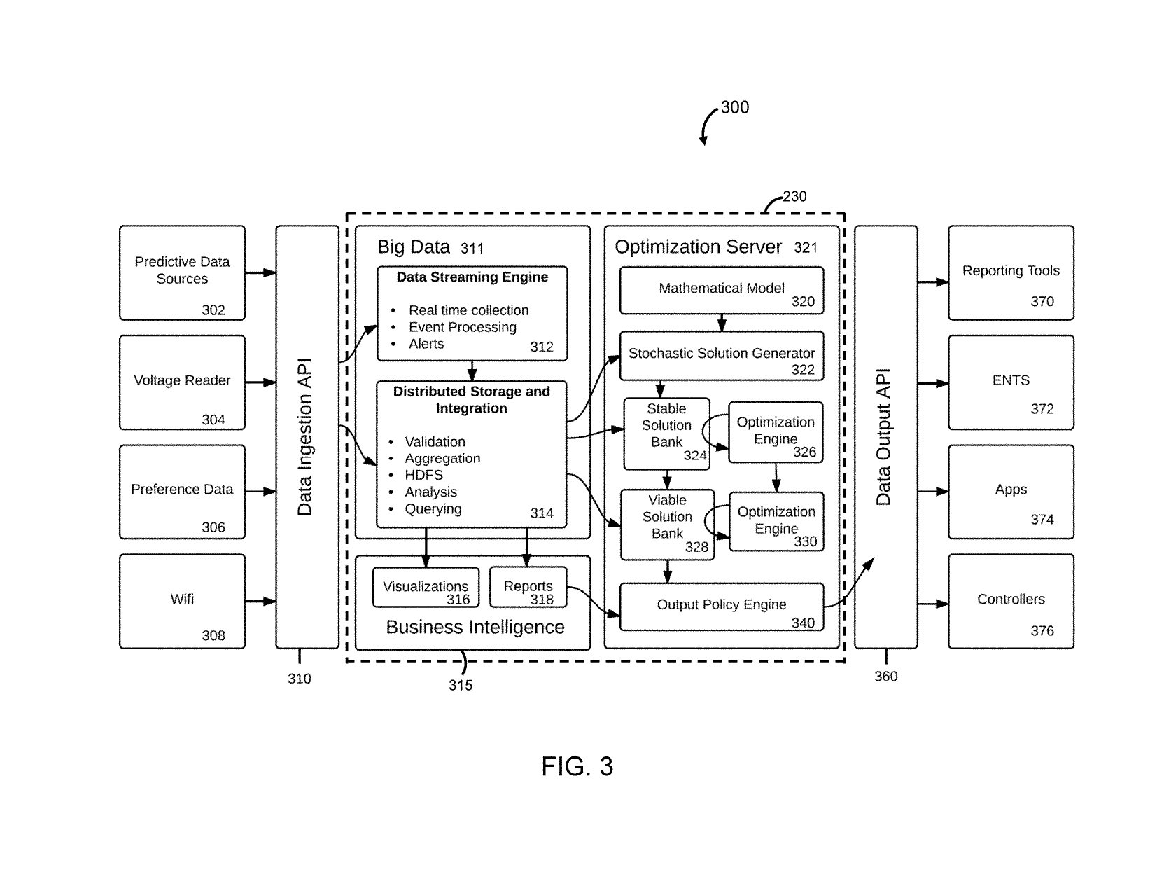

Referring to FIG. 3, shown there generally as 300 is a block diagram of a system for collecting preference data from networked-connected electricity-consuming devices and outputting global optimums, in accordance with at least one embodiment of the present invention. As illustrated, the components of the dynamical policy engine 230 discussed above with respect to FIG. 2 (as shown in dotted outline in FIG. 3) are made up of the big data 311 component and the optimization server 321. The data inputs (and/or mediums of transmission of such data inputs) into the dynamical policy engine 230 are shown to the left of the dynamical policy engine 230, as provided through a data ingestion Application Program Interface (API) 310 that allows for real time data collection. The determined optimums and configuration data generated from the dynamical policy engine 230 is shown to the right of the dynamical policy engine 230, being provided through a data output API 360.

The inputs shown in FIG. 3 are for an example embodiment where the networked devices that collect data about energy usage (e.g., smart meters or smart thermostats) and send information related to energy consumption. As illustrated, the inputs include predictive data sources 302 (e.g., external data that is used to configure the data models being generated in the dynamical policy engine 230), a voltage reader 304 (e.g., for reading the amount of energy consumed), and preference data 306 (as discussed above); some or all of which may be transmitted using various mediums for data transmission (e.g., such as a wireless networking protocol Wi-Fi 308).

The outputs shown in FIG. 3 may include reporting tools 370 (e.g., tools that allow for viewing of characteristics of the collected data and/or generated model), control signals or prices for devices having Essential, Non-Time Sensitive loads (ENTS) 372, other software applications 374, and Controllers 376. The output from the dynamical policy engine 230 to the devices with ENTS 372, Apps 374, and controllers 376 may allow the dynamical policy engine 230 to output control signals or prices so as to allow the determined global optimums to be achieved. For example, ENTS may be indicated in the preference data 220 discussed above with respect to the electricity loads which may activated at any point during a given time range (e.g., a dishwasher may be run from any time between 8 pm to 6 am).

Details of the components of the data analytics engine 230 will now be discussed in greater detail.

The big data component 311 performs functions related to analyzing the data (as may have traditionally been performed in the data analytics phase shown in FIG. 1). As shown, there may be a data streaming engine 312 for processing real time collection of data from the data ingestion API 310. The data streaming engine 312 may also perform functions related to event processing and alerts. The big data component 311 may also include a distributed storage and integration component 314. This component may perform functions related to storing and making the data received from the data ingestion API 310 available for access. In particular, the distributed storage and integration component 314 may be responsible for various functions related to the data such as storage (e.g., via use of the Apache™ Hadoop™ Distributed File System (HDFS)), validation, aggregation, analysis, and querying. The data stored in and by the distributed storage and integration component 314 may be outputted to various components that provide business intelligence functionality 315. For example, as illustrated, the business intelligence functions include visualizations 316 and reports 318.

As noted above, the dynamical policy engine 230 of the present embodiments is also able to perform multi-scale optimization and modelling. To perform such optimization and modelling, there may be an optimization server 321, which provides a number of different functions discussed below.

The mathematical model 320 provides the underlying mathematical model that relates the preference data 220 (as shown in FIG. 2) and collected device data 110 (as shown in FIGS. 1 and 2) transmitted from the networked devices to potential courses of action, and these courses of action to the welfare of the system. For example, in the example embodiment where the networked devices relate to energy consumption, the inputs related to time of day house occupancy from smart thermostats, or time of day consumption from smart meters, may serve as inputs into the mathematical model. The inputs may then be assigned a global welfare value based on the prices to charge for energy (e.g., a two price model having public and private prices, as discussed in greater detail below). In some embodiments, the mathematical model 320 may consider the preference data 220 being received from multiple networked physical items as forming a cooperative team of purchasers so as to affect the outputted market price(s).

The stochastic solution generator 322 pre-calculates probability distributions for possible solutions to the optimization problems, based on the mathematical model 320. For example, while the mathematical models 320 may provide the relationship between the preference data 220 and collective device data 110 inputs as they relate to prices that aim to achieve optimal electricity consumption levels, the stochastic solution generator 322 may provide probability distributions of different values potentially occurring for such inputs over a period of time (e.g., the probability distribution may be created from historical collected data stored in the distributed storage and integration component 314).

Using these probability distributions, the stochastic solution generator 322 may create candidate solutions in the search space for the optimal electricity consumption level. In some embodiments, there may be multiple stochastic solution generators 322 that are each working on a sub-problem, such that the candidate solution from one stochastic solution generator may be a partial solution for the overall system 300. In some embodiments, the stochastic solution generator 322 takes input from the distributed storage and integration component 314 and performs analytics on the data (as shown in FIG. 1) and/or processing for multi-scale optimization (as shown in FIG. 2).

Various optimization techniques may be used herein by the stochastic solution generator 322 to identify optimal solutions. For example, in some embodiments, a technique entitled “Leaders and Followers” (LaF) may be employed. LaF techniques have been shown to outperform other heuristic techniques, especially in high-dimensional spaces (e.g., involving many variables).

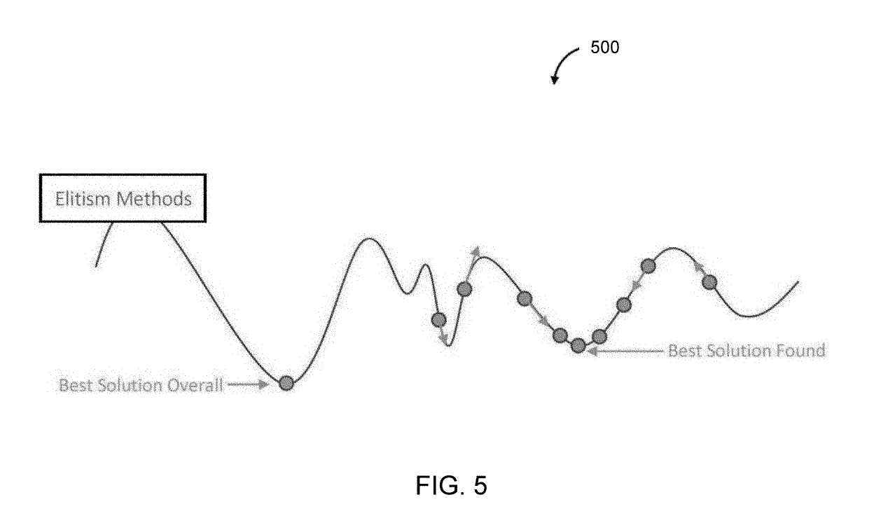

In LaF, in order to find an optimal solution, the LaF technique deploys a group of “explorers” and avoids “elitism”. The notion of “elitism” is that all of the explorers will be influenced by the best solution found so far. In a space that has many variables and many wells, elitism will cause all of the explorers to eventually become trapped and not look farther to seek better solutions. Referring briefly to FIG. 5, shown there generally as 500 is a diagram illustrating traditional techniques used to locate global optimums.

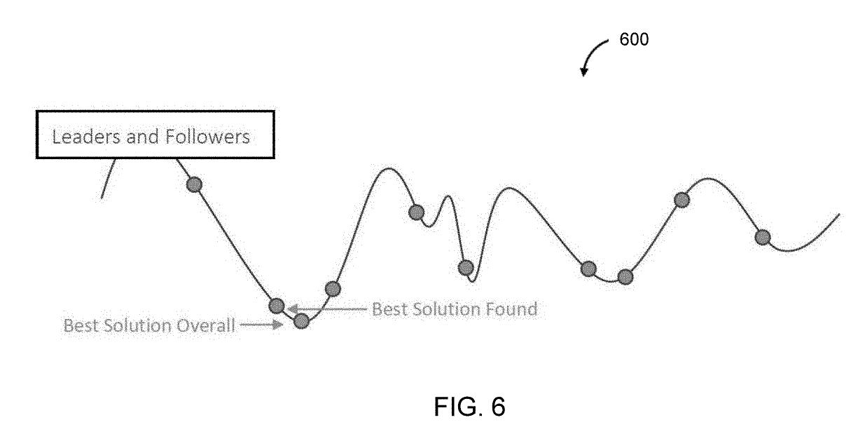

In contrast, LaF holds on to less attractive solutions that are not all influenced by the best solution found at the time. New solutions explore wells and additionally look in random directions from previously found solutions. Referring briefly to FIG. 6, shown there generally as 600 is a diagram illustrating techniques used to locate global optimums when a Leaders and Followers (LaF) technique is used.

This feature makes LaF ideal for large-scale dynamic systems with high levels of interactions and dependencies. Additional details of the LaF techniques are discussed in greater detail in Y. Gonzales-Fernandez and S. Chen, “Leaders and Followers—A New Metaheuristic to Avoid the Bias of Accumulated Information,” in 2015 IEEE Congress on Evolutionary Computation (CEC), 25-28 May 2015, pp. 776-783, the entire contents of which are incorporated by reference.

In the embodiments of the present disclosure, the multiple dimensions of a problem space are attempted to be solved by breaking the problem of optimal electricity consumption level down into many sub-problems. Partial solutions to these sub-problems can be attempted to be solved using various explorers in the LaF technique, which then gets aggregated for the purpose of identifying a global optimum. In the example environment where the networked devices are smart meters or smart thermostats, partial solutions may be directed to optimized outcomes for some select participants in the energy market but not others.

In some implementations, the LaF optimization procedure may be used with a relatively simple solution generator (e.g., a uniform random in a hyper cuboid) and a novel population management scheme (e.g., two populations that are merged with such that they have similar median fitness). However, in some other embodiments, instead of a simple solution generator, the stochastic solution generator 322 can be used to pre-calculate other feasible solutions close by based on the dynamical modelling performed in the mathematical model module 320. As used herein, the term feasible solutions refer to mathematically feasible solutions (e.g., solutions (which are feasible in view of the constraints and inputs of the mathematical model 320).

In addition to each feasible solution representing a complete description of the market, the probability distributions over this space of feasible solutions are estimated with the goal of finding other similar feasible solutions within the search space. Notably, this search space may be hierarchical in nature where there are some populations of subsolutions (e.g. matching of supply and demand within a given geographical region such as Germany) and a population of aggregate solutions (e.g. matching of supply and demand for a larger geographical region such as Europe that includes the given geographical region).

One of the key differences between LaF and other search techniques such as Particle Swarm Optimization (PSO) and Differential Evolution (DE) may be that the distinguishing feature of LaF is about how solutions are compared. In PSO and DE, their distinguishing features are how solutions are created. Thus, the use of dynamical modelling in the context of LaF may provide enhanced effectiveness as compared to other techniques. Further, by using a stochastic solution generator 322 integrated with dynamical modelling which only creates feasible solutions, a LaF-based optimization engine may be more efficient than other optimization engines which allow the generation of infeasible solutions and then have to apply penalty functions or repair operations to guide the search back to the feasible part of the search space.

The output of the LaF optimization engine is a set of robust partial and complete solutions that both move towards optimality for the current environment and maintain viability for potential changes to the environment. For example, if the day is windier than expected, the full set of solutions delivered by the dynamical policy engine 230 may not be too different from “normal” conditions but the final optimal solution may be different for each set of conditions. The LaF optimization engine can implement solutions under these and other unpredictable variable conditions. A potential advantage of this inherent robustness to the system is the ability to handle partial information. For example, if a failure in the telecommunication systems occurs, the dynamical policy engine 230 may still deliver solutions that are acceptable to these changes. In some embodiments of the invention, this may lead to the networked devices acting independently of the central system to activate the loads they are required to perform in a distributed manner that will still prevent a peak from occurring.

Referring still to FIG. 3, the stable solution bank 324 may store stable partial or complete solutions determined from the stochastic solution generator 322 (e.g., using the LaF technique, as discussed), and the optimization engine 326 interacting with the stable solution bank 324 may process such stable solutions to improve their optimizations.

The stable solutions stored in the stable solution bank 324 may then be validated against actual live conditions of the grid to identify solutions which are viable. A viable solution is a solution that is implementable for the market at a particular time. The stochastic solution generator 322 creates a feasible solution for a particular market, while the optimization engine uses these solutions to seek better ones. By the time an “optimal solution” is found however, it might not be implementable in the market, or it might not represent the best solution depending on new market conditions. Therefore, once stable solutions are found, they must be validated against external live conditions to identify solutions which are viable.

These viable solutions may then be stored in the viable solution bank 328, and further optimized using optimization engine 330.

In some embodiments, there may also be a distributed partial solution storage (also called a fog, not shown), which presents a number of specialized instances of optimization engines configured to solve for a partial solution of a given sub-problem (e.g., optimizing energy consumption for given neighborhoods, individual houses, or to match demand from a given energy source for which it is difficult to reduce production such as nuclear). The distributed partial solution (fog) may take input from the stochastic solution generator 322 with respect to the type of sub-problem that a given instance of an optimization engine is to search for a partial solution. It may also receive input with respect to the data on which its analysis is to be performed.

In some embodiments, as various partial solutions are being generated by the distributed partial solution (fog), there may be provided an optimization listener that can act as a “listener” to the partial solutions. As will be understood by persons skilled in the art, “Listener” is a software architecture model that allows a listening process or thread to observe the partial solutions being generated by the distributed partial solution (fog), and in response, provide configuration settings back into the instances of optimization engines attempting to arrive at the partial solutions. For example, the optimizer listener may provide updated configuration settings to the searches for partial solutions (fog), as a part of its attempt under the LaF technique to “explore” additional potential global optimum solutions. As noted, in the LaF technique, even as new globally optimal solutions are found, exploration in random directions may still continue to avoid “elitism”.

With the distributed partial solution (fog) continually being provided with real-time preference data 220 and collected data 110, these partial solutions can continue to be re-calculated. The solutions may then be re-generated as necessary according to market conditions, such as shifts in consumer preferences or changes in the supply of electricity (e.g., from wind or solar sources) as indicated by the received data. In conjunction, the optimization listener employing LaF techniques may listen on the available partial solutions—monitoring for the need to make large changes to the partial solutions to achieve the desired global optimum, while keeping track of global solutions already found which are as close to globally optimal as possible.

In this way, the system 300 achieves a high level of stability and is able to constantly learn and be updated from interactions in the networked devices. In the example where the problem space is to determine pricing information as noted above, the system also allows for risk analysis and real time pricing of electricity consumed by the networked devices. As the dynamical policy engine 230 constantly receives updated data from the networked devices, there will be a constant generation of inter-related partial solutions of a large-scale problem. Such problems are well suited for employing LaF techniques, as the environment will be continuously evolving and LaF techniques provide desirable optimization characteristics in such dynamically updated environments.

Referring still to FIG. 3, the outbound policy engine 340 takes the results of the viable solution bank 328 and/or the reports component 318 and selects specific actions/outputs to be offered to the output components 370, 372, 374, 376 through the data output API 360. As discussed below in greater detail, in some embodiments where the problem space is to optimize energy usage, one or more of these outputs may be a private price for energy specific to a particular geographical location (e.g., house, apartment, or business address).

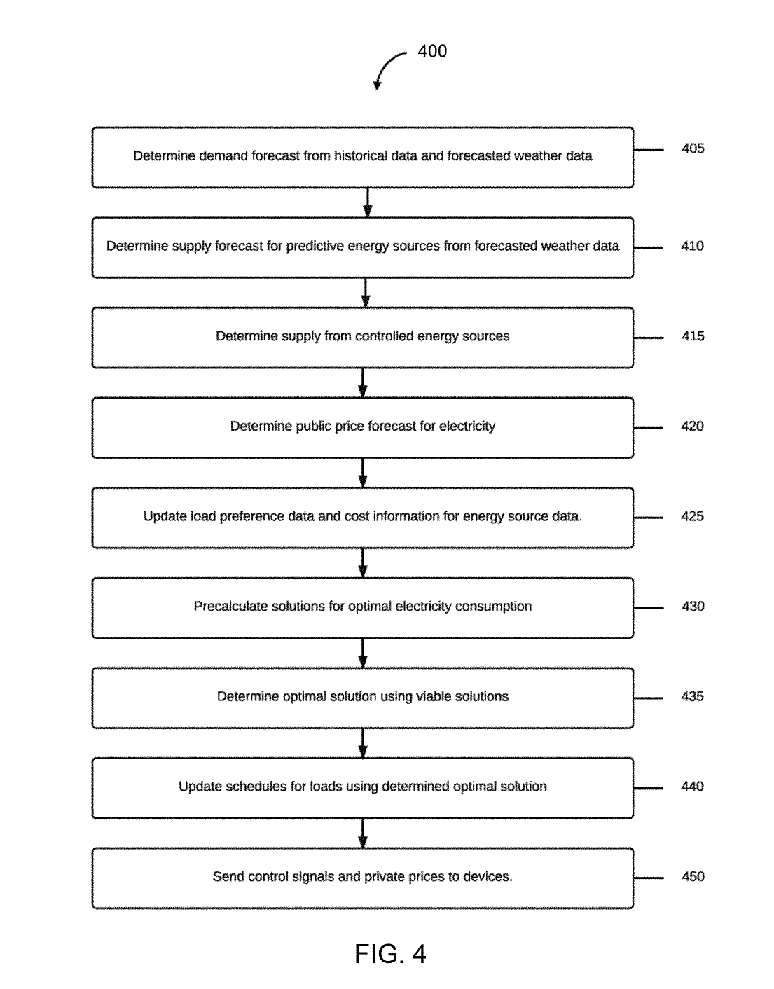

Referring to FIG. 4, shown there generally as 400 is a flowchart diagram for a method of managing electricity consumption on a power grid, in accordance with at least one embodiment of the present invention. In describing the method below in relation to FIG. 4, reference will also be made to the components of FIG. 3. Although discussed below as being performed in sequence, any number of these steps may be performed in parallel and in any order.

At 405, forecasted weather data may be retrieved/updated through the real time data ingestion API 310 and stored in the distributed storage and integration component 314 of the big data component 311. This data may be compared to historical demand, and using statistical methods a demand forecast over a future time range of ‘T’ minutes is determined and stored in the distributed storage and integration component 314.

At 410, information on predictive energy sources in the grid (e.g., wind and/or solar energy sources) may be stored in the distributed storage and integration component 314. For example, this may involve either forecasted predictive energy being retrieved and/or updated from a third party, or forecasted weather data is compared to energy source specifications and a predictive supply forecast being determined using statistical methods. The result for a future time range of ‘T’ minutes is stored in the distributed storage and integration component 314.

At 415, the energy supply from fixed sources (also known as controlled sources with a lead or lag time outside of the time range of ‘T’ minutes, such as nuclear energy sources) for a future time range of ‘T’ minutes is retrieved and/or updated through the data ingestion API 310 and stored in the distributed storage and integration component 314.

At 420, the forecasted price for energy over the future time range of ‘T’ minutes is either retrieved through the real time data ingestion API 310, and/or calculated using statistical methods through historical pricing data and forecasted supply and demand.

At 425, the preference data is loaded from networked devices through data ingestion API 310 and stored in the distributed storage and integration component 314. This step may also involve retrieving and/or updating cost information for both predictive and controlled energy sources, and storing such pricing information in distributed storage and integration component 314.

At 430, a solution is pre-calculated for an optimal electricity consumption level. This may be performed by the stochastic solution generator 322, and the determined solution may be stored in the stable solution bank 324. However, as the determined solutions are optimized, the optimization engine 326 may also create new solutions from existing solutions. When determining solutions, some or all of the various data ingested at steps 405 to 425 may be taken into account. For example, this may include newly-connected devices, and newly-submitted preference data. Likewise, any disconnected devices and outdated preference data may be removed from the optimization process.

Viable solutions may then be determined from the stable solutions stored in the stable solution bank 324. This may be performed by confirming the connections to the various devices and power sources, preference data, and that various networked devices are responsive to control signals. Identified viable solutions may then be stored in the viable solution bank 328, and further optimized using optimization engine 330.

At 435, an optimal solution may be determined using the viable solutions stored in the viable solution bank 328. At 440, based on the determined optimal solution from step 435, schedules for loads may be updated.

At 450, the best viable solution and real time price signals may then be sent to the data output API 360 (e.g., for controlling when ENTS are activated). As discussed herein, the private prices offered to certain individual networked devices may be lower if the device had offered longer time ranges in which a load may be activated (e.g., in doing so, providing more flexibility for the optimization engine to seek optimal electricity consumption levels). Control signals and private prices may then be transmitted to networked devices via the data output API 360 for a period of time less than the time range of ‘T’ minutes. If new information arrives during this period of time when the control signals and private prices are being transmitted, the optimal solutions may be adjusted, and the control signals and private prices may be updated accordingly.

Although the LaF technique has been discussed herein as an optimization technique that may be employed in the present embodiments, other optimization techniques may additionally or alternatively be used. For example, other techniques that may be used in the present embodiments to search for optimal solutions include the shuffled leaping frog algorithm, cultural algorithms, Particle Swarm Optimization (PSO), Differential Evolution (DE), and Evolution Strategy (ES). As will be understood by persons skilled in the art, the mathematical model component 320 may be updated accordingly to work with these types of optimization techniques.

The present embodiments are designed to operate on vast amounts of real time streamed data generated from networked devices. Various data collection, filtration, warehousing, and querying architectures may be employed to manage such data. As noted, in various embodiments, big data management engines, e.g., based on Hadoop™ infrastructures, may be used for implementation. The data management engines may be configured to have open interfaces towards raw data (e.g., as generated from various networked devices), and also towards the data engines noted above.

In various embodiments, one or more components of the systems of the present embodiments may be implemented on local systems internal to an organization, and/or in cloud-based servers. In some embodiments, the architecture discussed above may run in a standalone environment (e.g., this may be the case if it is desirable to do so in the context of the industrial problem being addressed). In some embodiments, the above architecture may serve as a module within a larger scale industrial software solution. In some embodiments, the system may employ large-scale cloud based designs that integrate micro-services software models running over virtual environments. In some embodiments, container based deployment models may be used. In some embodiments, one or more of the components noted above as forming part of a data analytics engine (shown in dotted outline in FIG. 3) may be provided on cloud-based services. In some instances, such deployments may be configured to be provided in an Infrastructure as a Service (IaaS) environment where cloud computing services are provided via virtualized computing resources over the Internet.

In some embodiments, the software functionality of the components discussed above may be run and deployed in a Software as a Service (SaaS) model. For example, in the scenario where the problem space to be optimized relates to the consumption of energy, the software components discussed above may be accessed by a networked physical item (e.g., the smart meters or smart thermostats discussed above) associated with energy consumers. This may allow the networked physical item to time and plan their consumption according to the control signals provided by the cloud-based above-noted data analytics engines. Viewed another way, implementation of such software functionality in the cloud may allow the services to be deployed to the IoT end user (e.g., households, drivers, and/or small businesses) to automatically monitor their use of energy, and to have their energy usage coordinated. This may allow energy consumers to achieve optimal energy and economic efficiency.

Additionally or alternatively, the SaaS deployment model may be compatible with Platform as a Service (PaaS) ecosystems for energy solutions. For example, various energy centric application development PaaS solutions are available (e.g., IBM™ Bluemix™ or GE™ Predix™). The components discussed above in relation to FIG. 3 may be integrated with such systems in a way that allows energy producers to access information related to the aggregated global optimal solutions and partial solutions to improve their operational and economic efficiency. In various embodiments, the results and outputs of the above components may be integrated into other applications also. In this way, the software functionality described above may be utilized with other applications to achieve improved economic outcomes (e.g., by matching demand to energy availability and avoiding the need for utilities to purchase energy at high peak period rates).

### Optimization for Public and Private Prices During Energy Consumption

As noted above, in some embodiments, the system described herein may be used in the context where the networked physical items provide preference data and sensor information about energy consumption (e.g., as received from smart meters, lightbulbs, and/or thermostats). In such contexts, the system can be configured to take the input and optimize for global optimums. The discussion below provides additional details in the scenario where the system of the present embodiments is configured to address particular problems arising in this energy consumption context.

Traditionally, electricity production responds directly to consumption levels. However, there are certain cases where it would be desirable if energy consumption responds to production. For example, such situations may arise in systems which rely on nuclear energy or clean energy sources such as wind and solar (e.g., because there may be difficulties related to storing excess electrical power generated by these energy sources during low demand periods). These “demand matching” and “load balancing” problems, and the associated energy price setting problems can be considered optimization problems. The confluence of these problems, with the restrictions imposed dynamically by variable user usage of energy, creates a complex search space with a dynamic set of variables and constraints that can be addressed by the present embodiments.

While traditional Big Data analytics may provide prediction of consumption patterns, it does not allow for the dynamic and live modification of consumption patterns to match generation. By configuring networked physical items to send preference data 220 (as shown in FIG. 2), the present embodiments allow for coordinated, system-wide behaviours that may lead to enhanced efficiencies for the consumers, the energy grid, and the energy producers. Moreover, these environments may employ the present embodiments to support automated decision making through one or more of the “Active Data” features noted above.

Traditionally, optimization methods in environments where there are multiple nodes are unconcerned about what happens outside of their local context, such that individual actions may not lead to a global optimum. In the context of the energy consumption, to achieve global optimal electricity consumption levels, a public price is set at an appropriate level so that the desired behaviour in local consumption is achieved. For example, to achieve the desired global optimum, such price signal may be set at a level that appears locally optimal to the individual energy consumer. In theory, this will result in the local energy consumer selecting a local optimum, so that the selection of local optimums at various nodes may collectively lead to a global optimum.

However, this may not always lead to a global optimum in an energy consumption environment where there is a single price for power at any given time during the day. This is especially so if the global optimum objective relates to load balancing. This is because once a global price is lowered, there will likely be a demand spike at the lower price point. Such a result may result in a large increase in demand than does not correctly achieve a globally optimal load balancing objective. Moreover, the single-price system provides no ability to spread out the demand evenly across a lower price period.

Accordingly, to address in part some of these shortcomings, in some embodiments of the system described herein, there may be a two price model. The two prices may include: (i) a public price which is available to all grid users, and (ii) a private price which is offered to each cooperating user for each specific coordinated action. This two-price model can be used to achieve load matching and load balancing by, for example, lowering the price privately for some users to marginally increase demand without risking a global demand spike. The two-price system described herein may provide an increased granularity in controlling the demand required of a power grid.

For example, such increased granularity may allow load matching problems to be more readily addressed by incrementally increasing the demand to match incremental increases in production from renewable energy sources (e.g., solar and wind energy sources which may not have consistent production levels). In certain scenarios, it may be the case that the forecasted availability of electricity is greater than a forecasted electricity consumption level for the power grid. As noted above, in these types of situations, traditional systems may generate a negative price that actually requires a given power utility to pay another power utility to take electricity off of its grid. At the same time, there may be households connected to the grid that actually would desire to consume this electricity, but avoids doing so due to energy costs indicated by public prices. This is a non-optimal solution. The presence of a private price in some of the present embodiments may allow for consumption to gradually increase to match the additional available supply, without causing a demand spike.

As discussed above, in some embodiments, the private prices determined for a networked device may be based on the time range it indicates that it can be operated in its preference data 220 (as shown in FIG. 2). Generally, the broader the time range a device indicates, the lower the price the utility provides the device. This is because the broader range may provide the dynamical policy engine 230 with greater flexibility in identifying optimal solutions overall. For example, in the scenario above where there is excess production in the grid, a broad time range in the preference data may give the power utility enhanced flexibility in outputting this extra production at a variety of times without requiring it to pay other utilities to consume the excess supply. In a particular embodiment, the networked device is a thermostat that is capable of receiving a preferred time temperature (or temperature range) over a time range as an input, which then gets transmitted to the dynamical policy engine 230. In turn, the dynamical policy engine may use such preference data to send signals to the thermostat to control the usage of heating or cooling during the time range.

In effect, providing a private price that is locally optimal for particular users may provide increased granularity in controlling demand, and thereby increase the likelihood that the individual locally-optimal actions selected result in a desired globally optimum solution.

The calculation of the public and private price signals may involve the optimization of a large scale problem in a dynamic environment. In some embodiments, the LaF techniques discussed above may be used to search for variations in the different public and private price signal variables that achieve the optimal solutions in view of various global load matching and load balancing objectives.

As has been discussed herein, the smart grid is an example scenario for using the embodiments described herein. Consumers produce data 110 that include energy consumption for domestic use, e.g. heating and air conditioning, and their preferences 220 for such activities. Moreover, through the addition of electric and thermal storage, micro-production devices such as solar panels and small generators, and an automated control system, the IoT consumer in a modern smart city becomes equipped with the tools to save energy, time shift their necessary consumption, and produce their own energy in a way that maximizes economic benefit on both an individual house and global level. As noted, the data may be stored and pre-processed in the fog (as discussed above), where partial clusters and partial load balancing can be performed. The IoT consumer can rely on the optimization and modelling functionality described herein to find virtual teammates to balance consumption.

The energy producers, on the other hand, can access the aggregated patterns of consumption. This information has the potential to reduce waste, lower costs, and plan for infrastructure investments. To reach this potential, an aggregated optimal schedule may be constructed. This schedule can be calculated using the LaF optimization techniques discussed above.

The well-being of the grid encompasses the well-being of all parties connected to it. As an intermediary, accurate pricing of energy leads to more optimal allocation of energy, and this increases the possibility of improved decision-making for the cities and institutions in charge of this infrastructure. Knowing accurate energy costs in real time may allow for better decision-making, and the emergence of new automated patterns of consumption.

### Other Potential Applications

Although the problem of achieving global optimums for energy consumption has been discussed above as an example embodiment in which the present systems can be used, it will be understood by persons skilled in the art that the systems described herein may be used to address any problem which has many variables being collected in real time from networked physical items and would benefit from advanced optimization algorithms. In these various other embodiments, inputs related to current or historical data may be inputted, and, in effect, an answer to the question “what particular group of decisions should be made at this particular point in time in order to achieve the greatest result” may be attempted to be answered. The decisions can then either be automatically fed into a policy engine in order to immediately initiate new actions, or be marked for review before being deployed to the live environment. Examples of problem spaces in which the present systems may be deployed include: automated railway control; truck dispatching; medicine supply and staff dispatching for hospitals; water routing for hydroelectric generation; recommendation algorithms in social media or in online purchases; and/or asset management and portfolio optimization.

### General Improvements to IoT Infrastructure

In another broad aspect of the present disclosure, the embodiment described herein may be considered as providing general improvements to IoT infrastructure formed from networked physical items. Traditional IoT environments may be considered to have a five-layer functional model including: Devices; Connectivity; Applications; Platforms; and Services. Each of these layers will be discussed briefly below.

Devices refer to the various networked physical items that have sensors, identifiers and gateways used to collect and convey information. Devices are designed and deployed to meet the application use case requirements. They can range from simple identifiers that provide specific information on the object, or more complex devices that have the ability to measure (e.g., sensors) and process data (e.g., gateways). In some instances, specific IoT devices may be provided for specific applications such as utility/energy consumption, health, transportation, home and/or finance.

Connectivity refers to how the Devices can be provided with network connectivity. In some instances, the Devices connect to the network directly or indirectly through another similar device (e.g., in mesh networks) or a gateway that is provisioned to support multiple devices. In some instances, connectivity can be provided through a number of physical media such as copper, fiber optical cable or over the air through a number of wireless technologies. Examples of connectivity would include the 2.5/3/4G cellular networks, as well as various local area solutions (ZigBee™, Wi-Fi™, etc.) and low power wide area solutions (weightless protocols, etc.), among others.

Applications define the use case of the device and include all the necessary functionality required to make use of the device for the intended purpose. For example, this layer may include the hardware and software architectures designed for various intended purposes. In some instances, there may be standardized IoT applications that address particular problems (e.g., health wearable devices).

Platforms refer to an optional software layer that may be provided to provision devices with some baseline functionality, as well as manage and control the devices. For example, where the application is in the utilities metering context, the Platform may be an underlying software layer that facilitates billing and fraud detection.

Services refer to the IoT service that is ultimately delivered to the end user. The service provider leverages all the previous layers noted above: Platforms, Applications, Connectivity and Devices. Examples of Services would include automotive automated diagnostic, medical geriatrics, and power consumption optimization.

Such traditional IoT environment configurations are generating increasing amounts of data. As noted above, there are some existing attempts to analyze such data to generate predictive models for the purpose of achieving local optimization. Notwithstanding such attempts, IoT networks still may face the following challenges: Geographical Elasticity; Large Scale Monitoring; Real Time Interactions; and Heterogeneity. Each of these challenges will be discussed in greater detail below.

Geographical Elasticity refers to the mobile and semi-mobile nature of nodes in the IoT environment. These nodes are part of a large-scale system of signal producers and processors, but they may not be consistently connected to centralized infrastructures.

Large Scale Monitoring refers to the volume of sensors and devices deployed by IoT networks. Because of the exponential increase in such volume, the resultant “data lake” presents new computational challenges and optimization opportunities. For example, as may be achieved with the system described herein, one such opportunity is to configure the various nodes to be self-autonomous by having them collaborate with each other through localized decision making.

Real Time Interactions refers to a level of near instantaneous control over the action of nodes in an IoT network. This is above that of being passive data collectors. Specifically, traditional IoT environments do not allow for real time controlling of the nodes (e.g., to allow for achievement of global optimums as opposed to just local optimums).

Heterogeneity refers to the diverse array of private, open, and public networks that IoT environments can consist of.

The present embodiments may address one or more of the foregoing shortcomings by providing an architecture that scales to support the high volume and velocity of data and type of analytics required to provide real time interactions.

As noted, the architecture may employ data storage/warehousing techniques that allow for efficient and real time large scale data capture. In some embodiments, frameworks such as Apache™ Hadoop™ may form the basis of the data availability and reliability architecture. In some embodiments, data policies for archiving and querying may provide the required reliability and disaster recovery handling. In some embodiments, cloud based deployments may allow for scalability models for the Information Technology (IT) and backend architectures. Linear scalability and performance with scale may be achieved by using the appropriate Big Data management architectures. In some embodiments, real-time data processing systems (e.g., TIBCO™ StreamBase™ or Amazon Web Services™ Kinesis™) may be employed to achieve processing of high velocity data streams in near real time for alerts and analysis. Such real time processing systems may allow for horizontal scaling, large-scale events processing, reliable data management and dynamic events handling.

The architecture may then provide data science applications overlaid on top of these data storage mechanisms. For example, the overall data science framework (e.g., the distributed partial solution (fog) and optimizer engines discussed above in respect of FIG. 3 discussed above) may sit on top of the data storage mechanisms to perform intelligent data analysis and optimization. In some embodiments, as noted above, such intelligent data analysis and optimization may include an extensive set of machine learning and data modelling techniques (e.g., to perform the dynamical modelling discussed above). In some embodiments, techniques such as deep learning may be employed. In some embodiments, techniques involving additions to random forest and gradient boosted decision trees may be employed to address particular problems that arise in certain industrial applications.

In some embodiments, these data analytics techniques may complement existing sets of machine learning and data mining algorithms by specifically focusing on clustering and predictive modelling in high dimensional spaces. In various embodiments, such activities may be based on imprecise, uncertain and incomplete information, efficient statistical data summarization and features extraction algorithms, as well as large-scale real-time data stream management.

For simplicity and clarity of illustration, where considered appropriate, reference numerals may have been repeated among the figures to indicate corresponding or analogous elements or steps. In addition, numerous specific details have been set forth in order to provide a thorough understanding of the exemplary embodiments described herein. However, it will be understood by those of ordinary skill in the art that the embodiments described herein may be practiced without these specific details. In other instances, certain steps, signals, protocols, software, hardware, networking infrastructure, circuits, structures, techniques, well-known methods, procedures and components have not been described or shown in detail in order not to obscure the embodiments generally described herein.

Furthermore, this description is not to be considered as limiting the scope of the embodiments described herein in any way. It should be understood that the detailed description, while indicating specific embodiments, are given by way of illustration only, since various changes and modifications within the scope of the disclosure will become apparent to those skilled in the art from this detailed description.

The embodiments of the methods described herein may be implemented in hardware or software, or a combination of both. In some cases, embodiments may be implemented in one or more computer programs executing on one or more programmable computing devices (e.g., the various devices discussed below) including at least one processor (e.g., a microprocessor), a data storage device (including in some cases volatile and non-volatile memory and/or data storage elements), at least one communications interface (e.g., a network interface card for wired or wireless network communications, as discussed below), at least one input device, and at least one output device.

Those of skill in the art will understand that the above description of illustrative embodiments of the disclosure does not limit the implementation of embodiments of the disclosure to any particular computer programming language. For example, in some embodiments, each program, module, or application may be implemented in a high level procedural or object oriented programming and/or scripting language to communicate with a computer system. However, the programs can be implemented in assembly or machine language, if desired. In any case, the language may be a compiled or interpreted language.

More specifically, embodiments of the disclosure may be implemented in any computer programming language provided that the operating system (O/S) provides the facilities that may support the present disclosure. For instance, an embodiment of the present disclosure may be implemented in part in the JAVA™ computer programming language (or other computer programming languages such as C, C++, Objective-C, C#, or Swift). Those skilled in the art will also appreciate that any limitations presented by such an embodiment would be a result of a particular type of operating system or computer programming/scripting language and would not be a limitation of the present disclosure.

In some embodiments, the networked devices and methods as described herein may also be implemented as a transitory or non-transitory computer-readable storage medium configured with a computer program, wherein the storage medium so configured causes a computing device to operate in a specific and predefined manner to perform at least some of the functions as described herein. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled, non-compiled, bytecode, or other forms in which the instructions may be interpreted or translated.

Additional aspects and advantages of the present disclosure will be apparent in view of the preceding description.

All publications and patent applications mentioned in this specification are herein incorporated by reference to the same extent as if each individual publication or patent application was specifically and individually incorporated by reference.

While the foregoing disclosure has been described in some detail for purposes of clarity and understanding, such disclosure is provided by way of example only. It will be appreciated by one skilled in the art, from a reading of the disclosure that various changes in form and detail of these exemplary embodiments can be made without departing from the true scope of the disclosure. For example, it should be understood that acts and the order of the acts performed in the processing described herein may be altered, modified and/or augmented (whether or not such steps are described in the claims, figures or otherwise in any sequential numbered or lettered manner) yet still achieve the desired outcome. While processes or blocks are presented in a given order, alternative examples may perform routines having steps, or employ systems having blocks, in a different order, and some processes or blocks may be deleted, moved, added, subdivided, combined, and/or modified to provide alternatives or sub-combinations. Each of these processes or blocks may be implemented in a variety of different ways. Also, while processes or blocks are at times shown as being performed in series, these processes or blocks may instead be performed in parallel, or may be performed at different times.

Where a component (e.g. a model, processor, scheduler, display, data store, software module, assembly, device, circuit, etc.) is referred to above, unless otherwise indicated, reference to that component should be interpreted as including as equivalents of that component any component which performs the function of the described component (i.e., that is functionally equivalent), including components which are not structurally equivalent to the disclosed structure which performs the function in the illustrated exemplary embodiments of the invention.

As used herein, the wording “and/or” is intended to represent an inclusive-or. That is, “X and/or Y” is intended to mean X or Y or both. Moreover, “X, Y, and/or Z” is intended to mean X or Y or Z or any combination thereof.

What is claimed is:

1. A method of managing electricity consumption on a power grid, comprising:
receiving, for a first network-connected electricity-consuming device connected to the power grid, first preference data indicating preferences for usage of the first device during a time range;
receiving a forecasted availability of electricity on the power grid during the time range;
determining an optimal electricity consumption level for the power grid that matches the forecasted availability of electricity during the time range, wherein the optimal electricity consumption level comprises electricity to be consumed by the first device during the time range indicated in the first preference data; and
determining a first private price for electricity consumed by the first device during the time range, the first private price being different from a public price of electricity during the time range;
wherein the first private price is determined so that the optimal electricity consumption level, when adjusted for the altered consumption of the first device as a result of the first private price, matches the forecasted energy availability during the time range is achieved.

2. The method of claim 1, further comprising:
receiving, for a second network-connected electricity-consuming device connected to the power grid, second preference data indicating preferences for usage of the second device during a time range, wherein the second preference data is received prior to the determining of the optimal electricity consumption level, and the optimal electricity consumption level comprises electricity to be consumed by the second device during the time range as indicated in the second preference data; and
determining a second private price for energy consumed by the second device during the time range, the second private price being different from the public price of electricity during the time range, and wherein the second private price is available to the second device simultaneous with the first private price being made available to the first device;
wherein the second private price is determined so that the optimal electricity consumption level, when adjusted for the altered consumption of the second device as a result of the second private price, matches the forecasted energy availability during the time range is achieved.

3. The method of claim 2, wherein the optimal electricity consumption level is a substantially flat demand between the first device and the second device during the time range, and the first private price and the second private price are determined in a coordinated matter to achieve the flat demand.

4. The method of claim 1, wherein the forecasted availability of electricity is greater than a forecasted electricity consumption level for the power grid, and the first private price is determined to be lower than the public price, so that the electricity consumed by the first device will increase to achieve the optimal electricity consumption level that matches the forecasted availability of electricity.

5. The method of claim 1, wherein the first preference data comprises an indication that the first device may be operated at any time during the time range, and the first private price is determined in part based on a size of the time range associated with the first preference data.

6. The method of claim 1, wherein the first device is capable of being operated in a plurality of operational settings that each consume different amounts of electricity when the first device is used with the operational setting, and wherein the first preference data comprises an indication of a subset of the plurality of the operational settings that the first device can be used with during the time range, and wherein the first private price is determined in part based on the subset of the plurality of operational settings.

7. The method of claim 1, wherein the Leaders and Followers (LaF) optimization technique is used to determine the optimal electricity consumption level.

8. The method of claim 1, wherein when determining the optimal electricity consumption level for the power grid during the time range, the method further comprises pre-calculating feasible solutions using a stochastic solution generator and the feasible solutions comprise the first private price for electricity consumed by the first device during the time range.

9. The method of claim 8, wherein the feasible solutions are validated against live conditions of the power grid, and upon successful validation, the first private price is transmitted to the first device.

10. A computer readable medium storing instructions to manage electricity consumption on a power grid, the instructions for execution by one or more processors, wherein when the instructions are executed by the one or more processors, the one or more processors:
receive, for a first network-connected electricity-consuming device connected to the power grid, first preference data indicating preferences for usage of the first device during a time range;
receive a forecasted availability of electricity on the power grid during the time range;
determine an optimal electricity consumption level for the power grid that matches the forecasted availability of electricity during the time range, wherein the optimal electricity consumption level comprises electricity to be consumed by the first device during the time range indicated in the first preference data; and
determine a first private price for electricity consumed by the first device during the time range, the first private price being different from a public price of electricity during the time range;
wherein the first private price is determined so that the optimal electricity consumption level, when adjusted for the altered consumption of the first device as a result of the first private price, matches the forecasted energy availability during the time range is achieved.

11. A network-connected electricity-consuming device, the device comprising:
a processor configured to control usage of the device according to preference data indicating preferences for usage of the device during a time range;
wherein the processor is further configured to receive a private price for electricity consumed by the device, the private price being different from a public price of electricity during the time range,
and wherein the private price is determined so that a forecasted optimal electricity consumption level for the power grid during the time range, when adjusted for the altered consumption of the first device as a result of the first private price, matches a forecasted energy availability on the power grid during the time range.

12. A system for managing electricity consumption on a power grid, the system comprising:
a first network-connected electricity-consuming device connected to the power grid; and
a server communicably connected to the first network-connected electricity-consuming device, wherein the server comprises one or more processors and one or more memories storing instructions which, when executed by one or more processors, cause the one or more processors to:
receive, for the first network-connected electricity-consuming device connected to the power grid, first preference data indicating preferences for usage of the first device during a time range;
receive a forecasted availability of electricity on the power grid during the time range;
determine an optimal electricity consumption level for the power grid that matches the forecasted availability of electricity during the time range, wherein the optimal electricity consumption level comprises electricity to be consumed by the first device during the time range indicated in the first preference data; and
determine a first private price for electricity consumed by the first device during the time range, the first private price being different from a public price of electricity during the time range;
wherein the first private price is determined so that the optimal electricity consumption level, when adjusted for the altered consumption of the first device as a result of the first private price, matches the forecasted energy availability during the time range is achieved.

13. The system of claim 12, further comprising:
a second network-connected electricity-consuming device connected to the power grid;
wherein the server is communicably connected to the second network-connected electricity-consuming device, and the server is further configured to:
receive, for the second network-connected electricity-consuming device connected to the power grid, second preference data indicating preferences for usage of the second device during a time range, wherein the second preference data is received prior to the determining of the optimal electricity consumption level, and the optimal electricity consumption level comprises electricity to be consumed by the second device during the time range indicated in the second preference data; and
determine a second private price for energy consumed by the second device during the time range, the second private price being different from the public price of electricity during the time range, and wherein the second private price is available to the second device simultaneous with the first private price being made available to the first device;
wherein the second private price is determined so that the optimal electricity consumption level, when adjusted for the altered consumption of the second device as a result of the second private price, matches the forecasted energy availability during the time range is achieved.

14. The system of claim 13, wherein the optimal electricity consumption level is a substantially flat demand between the first device and the second device during the time range, and the first private price and the second private price are determined in a coordinated matter to achieve the flat demand.

15. The system of claim 12, wherein the forecasted availability of electricity is greater than a forecasted electricity consumption level for the power grid, and the first private price is determined to be lower than the public price, so that the electricity consumed by the first device will increase to achieve the optimal electricity consumption level that matches the forecasted availability of electricity.

16. The system of claim 12, wherein the first preference data comprises an indication that the first device may be operated at any time during the time range, and the first private price is determined in part based on a size of the time range associated with the first preference data.

17. The system of claim 12, wherein the first device is capable of being operated in a plurality of operational settings that each consume different amounts of electricity when the first device is used with the operational setting, and wherein the first preference data comprises an indication of a subset of the plurality of the operational settings that the first device can be used with during the time range, and wherein the first private price is determined in part based on the subset of the plurality of operational settings.

18. The system of claim 12, wherein the server uses the Leaders and Followers (LaF) optimization technique to determine the optimal electricity consumption level.

19. The system of claim 12, wherein when determining the optimal electricity consumption level for the power grid during the time range, the server is further configured to pre-calculate feasible solutions using a stochastic solution generator, and the feasible solutions comprise the first private price for electricity consumed by the first device during the time range.

20. The system of claim 19, wherein the feasible solutions are validated against live conditions of the power grid, and upon successful validation, the first private price is transmitted to the first device.
